(19) United States
(12) Patent Application Publication
(10) Pub. No.: US 2024/0269961 A1
(43) Pub. Date: Aug. 15, 2024

(54) MINERAL FIBRE REINFORCEMENT FOR FLEXIBLE FLOOR COVERING SLABS

(71) Applicants: SAINT-GOBAIN ADFORS, COURBEVOIE (FR); GERFLOR, LYON (FR)

(72) Inventors: Guillaume NORMAND, PARIS (FR); Christoph LINGELBACH, ABENSBERG (DE); Sylvain DURAND, VILLEURBANNE (FR)

(21) Appl. No.: 18/570,449

(22) PCT Filed: Jun. 15, 2022
(86) PCT No.: PCT/FR2022/051159

§ 371 Date: Dec. 14, 2023

(30) Foreign Application Priority Data
Jun. 15, 2021 (FR) FR2106296

(51) Int. Cl. B32B 5/26; B32B 5/02; E04F 15/10

(52) U.S. Cl. CPC B32B 5/279; B32B 5/022; B32B 5/026; E04F 15/105; B32B 2255/02; B32B 2255/26; B32B 2255/28; B32B 2260/023; B32B 2260/046; B32B 2262/101; B32B 2262/16; B32B 2307/412; B32B 2307/554; B32B 2307/718; B32B 2307/724; B32B 2307/7376; B32B 2419/04

(57) ABSTRACT

A mat/mesh laminate for flexible floor covering slabs is formed by a glass fiber mat, bonded by a first organic polymer, having an air permeability, measured in accordance with standard NF EN ISO 9237 at a pressure of 200 Pa, of between 6000 and 12,000 l/m²·s, and by a glass yarn mesh having a titer of between 30 and 150 tex that is coated with a second organic polymer.

The invention relates to a complex glass fiber reinforcement for flexible floor covering slabs which makes it possible to limit the coefficient of thermal expansion of the slabs, and also to the flexible floor covering slabs comprising this complex glass fiber reinforcement.

Floor coverings referred to as “LVT” (Luxury Vinyl Tiles) are multilayer floor coverings based on PVC that are thicker and more durable than standard PVC floors. They are generally sold not in the form of rolls, but in the form of individual slabs which are optionally adhesive.

A distinction is conventionally made between, on the one hand, flexible floor covering slabs in accordance with standard ISO 24344/2008, and, on the other hand, rigid slabs that do not bend significantly under their own weight when they are held by one end. The latter are generally laid freely, without adhesives, with a peripheral space between the floor covering and the wall called an expansion joint. Rigid slabs, when they are subjected to an increase in temperature (exposure to the sun near a window, close to heating, underfloor heating, etc.) expand while pushing against one another and without deforming, as long as the expansion joint is sufficiently wide.

In the case of flexible floor coverings, providing a peripheral expansion joint is generally insufficient. When flexible PVC slabs are exposed to an increase in temperature, thermal expansion in the direction of the plane of the coating almost always causes warping that is very troublesome from an aesthetic perspective.

The present invention aims to propose a solution to the appearance of such defects in the flatness of flexible floor covering slabs by effectively limiting the coefficient of thermal expansion of the slabs, without however excessively stiffening them.

It is known to use reinforcing structures based on organic or mineral fibers to reinforce PVC slabs. The reinforcing structures may be individual fibers, nonwoven mats, woven textiles, meshes, in particular based on glass yarns, or a combination of such structures. Of course, when it is desired to limit the thermal expansion of the slabs, the use of reinforcing structures based on mineral fibers, which inherently have a much lower coefficient of thermal expansion than thermoplastic polymers, is particularly advantageous.

However, the difference between the coefficient of expansion of the reinforcement made of mineral fibers and that of the thermoplastic organic polymer may cause delamination when the bond between the reinforcement and the thermoplastic polymer is insufficient.

The risk of delamination is particularly great in the case of slabs manufactured not by coating/gelling PVC plastisol but by bringing the reinforcement into contact with plasticized PVC, under application of heat and pressure. The plasticized PVC can then be in the form of granules, sheets or a mass of PVC extruded directly onto the reinforcement. In this type of manufacturing process that does not use plastisol but rather previously plasticized PVC, the interface between the reinforcement and the plasticized PVC constitutes a weak zone, capable of initiating delamination.

The aim of the present invention is to propose reinforcements for PVC slabs which make it possible to limit both the thermal expansion of flexible PVC slabs and the risk of delamination at the PVC/reinforcement interface. The applicant has discovered that it is possible to achieve this dual aim using mat/mesh laminates that are sufficiently “open” to allow the PVC, in contact with the reinforcement, to penetrate into and through the latter so as to establish adhesive contact with the thermoplastic polymer located on the other face of the reinforcement. The adhesive contact between the two layers of thermoplastic polymer surrounding the reinforcement based on mineral fibers is all the stronger, the greater the contact surface between the two polymer layers is. However, when using reinforcements of the mat/mesh laminate type with a mat that is too “open”, the thermal expansion of the slabs is not effectively limited if the mesh of the laminate does not effectively compensate for the lower mechanical strength of the mat.

The mat/mesh laminates of the present invention consequently combine a mat with relatively high air passage permeability and a mesh consisting of yarns having a high titer.

The present application more particularly relates to a mat/mesh laminate, formed
by a glass fiber mat, bonded by a first organic polymer, having an air permeability, measured in accordance with standard NF EN ISO 9237 at a pressure of 200 Pa, of between 6000 and 12000 l/m²·s, preferably between 7000 and 11000 l/m²·s,
and by a glass yarn mesh having a titer of between 30 and 150 tex that is coated with a second organic polymer.

As explained in the introduction, the high air permeability of the glass fiber nonwoven mats used for the manufacture of the laminates is an important parameter. If the glass fiber network forming the mat were tighter, the PVC of the layers adjacent to the laminate would be mainly in contact with the mat/mesh complex, but very little with the other PVC layer in contact with the other face of the complex. The direct adhesive contact between the two PVC layers located on either side of the complex is an important factor in preventing delamination.

The glass mat used in the present invention is a nonwoven textile, manufactured by a wetlaid process or by a drylaid process, for example by a drylaid carded process or by an airlaid process. The glass mat is preferably a nonwoven textile manufactured by a wet process.

It advantageously contains short and relatively wide glass fibers, having a length of between 10 and 30 mm, in particular between 12 and 25 mm, advantageously having a diameter of between 11 μm and 18 μm, preferably between 12 μm and 17 μm.

The organic polymer used to bond the glass fibers of the glass fiber mat may in principle be any organic polymer that, after drying and curing, makes it possible to give the glass mat a cohesion that withstands the bonded mat being brought into contact with water. Consequently, the organic polymer of the binder is preferably a thermosetting polymer advantageously selected from urea-formaldehyde resins, melamine-formaldehyde resins, phenol-formaldehyde resins, acrylic resins and mixtures of these resins, preferably from urea-formaldehyde resins. The thermosetting polymer can also be a polyester binder, free of formaldehyde, advantageously formed by the esterification of sugars and/or hydrogenated sugars and of at least one polycarboxylic acid, preferably citric acid, in the presence of a catalyst, preferably sodium hypophosphite, such as those described in applications WO10/029266, WO2013/014399, WO2013/021112, WO2015/132518, WO2015/159012, or a thermosetting binder obtained from Maillard reagents, as described in international application WO2007/014236.

It is advantageously applied in the form of a solution of monomeric or oligomeric reactants (formaldehyde-based resins) or in the form of a latex (acrylic resins).

The curing of the binder of the glass fiber mat takes place for example by heating at a temperature between 180 and 230° C. for a duration of between 5 seconds and 5 minutes, preferably between 10 seconds and 2 minutes.

The binder is generally applied in an amount, expressed as solids, between 10 and 35% by weight, preferably between 15 and 25% by weight relative to the total weight of the glass fiber mat.

The bonded glass fiber mat used for manufacturing the complex advantageously has a mass per unit area of between 25 and 50 g/m², preferably between 30 and 45 g/m², in particular between 32 and 40 g/m², ideally between 32 and 39 g/m².

The thickness thereof is advantageously between 250 μm and 500 μm, preferably between 270 μm and 400 μm, and in particular between 300 μm and 350 μm.

The binder of the glass mat moreover advantageously contains flame retardants selected from metal hydroxides, metal hydrates and hydrated carbonates. Mention may be made, as examples of such mineral flame retardants, of magnesium hydroxide (Mg(OH)₂) or aluminum hydroxide (AlO(OH)₃), which are the most commonly used, or else huntite (3MgCO₃·CaCO₃) and hydromagnesite (4MgCO₃·Mg(OH)₂·4H₂O). These flame retardants break down via an endothermic reaction, releasing water and/or CO₂.

A glass yarn mesh (or glass fiber mesh or glass fiber grid) is then adhesively bonded to the glass fiber mat described above. This glass yarn mesh may be a knitted mesh, a woven mesh or a spun mesh (laid scrim). Use will preferably be made of a knitted glass yarn mesh.

The warp yarns and the weft yarns of the mesh preferably have a titer of between 30 and 140 tex. The titer of the warp yarns may in principle be different from that of the weft yarns, but in order to give the flexible PVC slab the most uniform properties possible, it is preferred that the glass yarn mesh consists of weft yarns and warp yarns all having the same titer.

The “density” of the weft yarns and warp yarns is advantageously between 3 and 4 yarns/cm.

In a preferred embodiment, the glass fibers forming the mesh are twisted yarns. This twisting generally increases the breaking strength of the yarns and the mesh.

The glass yarns forming the mesh advantageously have between 10 and 30 twists/m, preferably from 15 to 28 twists/m.

The adhesive used to fix the mesh on the glass mat is preferably also used as binder or coating for the mesh; or, to put it the other way round, the second organic polymer coating the mesh is advantageously used as adhesive for fixing the mesh to the glass mat. A mesh of non-bonded glass yarns, referred to as “greige”, is impregnated with a polymeric composition (“adhesive”) and brought into contact, under pressure and immediately after its impregnation, with the bonded glass fiber mat, the binder of which has already cured. The method consists in saturating the mesh with a suspension of the second organic polymer by a pad impregnation method, then in pressing the materials together and finally in drying the assembly by exposure to infrared radiation and/or by convective drying (hot air) and/or by drying by contact with heated rollers.

The glass yarn mesh is then adhesively bonded to the glass fiber mat by means of the second organic polymer which covers the mesh.

The adhesive that provides adhesion between the mesh and the mat may however be different from the coating of the mesh. This embodiment can be beneficial in particular for spun meshes which, in the unbonded state, do not form a greige-type textile allowing easy handling of the mesh for the purpose of bringing into contact with the web. For the spun meshes, it may therefore be advantageous to prepare them beforehand “off-line” using a binder different from the adhesive which will be used to adhesively bond the mesh to the glass mat.

The second organic polymer used for coating the glass yarn mesh may be selected for example from the group consisting of acrylic copolymers, styrene-butadiene rubbers (SBR), poly(vinyl acetate), poly(vinylidene chloride) (PVDC), poly(vinyl chloride) (PVC) and copolymers based on vinyl acetate, vinylidene chloride, vinyl chloride and/or other comonomers.

The final mat/mesh laminate advantageously has a mass per unit area of between 70 and 150 g/m², preferably between 75 and 120 g/m². The total thickness thereof is between 0.45 and 0.80 mm, preferably between 0.50 mm and 0.75 mm.

The tensile breaking strength thereof is between 400 and 1000 N/5 cm.

The mat/mesh laminate generally has an organic matter content, determined by the loss on ignition (LOI), of between 30 and 35% relative to the total weight of the laminate.

The present application also relates to a flexible slab for floor coverings based on poly(vinyl chloride) (PVC) comprising a mat/mesh laminate as described above.

In the present application, flexible slab or flexible floor covering means multilayer structures having flexibility enabling them to meet the requirements of standard ISO 24344:2008. In this standard, flexibility is defined by the ability of a multilayer structure to be wound around a mandrel having a diameter of 20 mm, without forming fissures or cracks. The slab of the present application, subjected to the test of standard ISO 24344:2008, thus does not exhibit breaks, fissures, cracks or other permanent defects resulting from the winding.

The mat/mesh laminate is preferably the only reinforcement of the flexible slab of the invention; in other words, the reinforcing slab does not include other textiles based on glass fibers or yarns.

The laminate is located in the mid-region of the slab, hereinafter referred to as base layer, and is sandwiched between two layers of plasticized PVC in adhesive contact respectively with the two faces of the mat/mesh laminate.

In a preferred embodiment, the flexible floor covering slab of the present invention comprises
a base layer including an upper face and a lower face, said base layer consisting of a mat/mesh laminate according to the invention and of two layers made of plasticized PVC in contact respectively with the two faces of the mat/mesh laminate,
a decorative layer printed on the upper face of the base layer,
a transparent wear layer, covering the decorative layer printed on the upper layer of the base layer.

In the present application, “upper face” of a layer means the face of said layer that is oriented toward the user once the floor covering has been laid and is ready for use, and “lower face” means the face oriented toward the floor after laying the floor covering. By analogy, the adjective “lower”, when it describes a structure, in particular a layer, indicates that this structure/layer is closer to the ground/support than another structure/layer. The adjective “upper” indicates that the structure/layer in question is further from the floor than another structure/layer.

The base layer of the slab of the present invention is therefore a three-layer structure consisting of a mat/mesh laminate and of two layers made of thermoplastic polymer, preferably PVC, which are in adhesive contact with the two faces of the mat/mesh laminate. Due to the high air permeability of the mat used for the manufacture of the laminate, the two layers made of thermoplastic polymer are also directly in contact with one another through the openings in the mat.

The PVC of the two thermoplastic sheets or layers of the base layer is non-expanded PVC, which is plasticized and contains fillers. Its density is typically greater than 1.4 g/cm³, preferably greater than 1.5 g/cm³ and does not generally exceed 2.0 g/cm³.

The plasticized PVC generally contains an amount of plasticizer of between 20 and 70 parts, preferably between 30 and 50 parts per 100 parts of PVC resin.

The plasticizers are known plasticizers. Mention may be made, by way of examples, of diisononyl phthalate (DINP), diisodecyl phthalate (DIDP), dioctyl terephthalate (DOTP), diisononyl 1,2-cyclohexanedicarboxylate (DINCH), plasticizers of the family of benzoates and adipates, epoxidized soybean oil (ESBO) and octyl epoxystearate (OES).

The amount of fillers present in the plasticized PVC of the two layers of the base layer is generally between 70 and 300 parts, preferably between 100 and 200 parts per 100 parts of PVC resin.

In a known manner, use can be made of mineral fillers such as clays, silica, chalk, kaolin, talcum and calcium carbonate.

The base layer, formed by the mat/mesh laminate and by the two layers of PVC in contact therewith, generally has a total thickness of between 0.8 and 2.8 mm.

The base layer of the flexible slab according to the invention cannot in principle be manufactured by coating the mat/mesh complex with a plastisol composition followed by a step of gelling by heating. Indeed, the significant degree of opening of the reinforcement makes the coating step difficult, since liquid plastisol is generally not sufficiently retained by the mat/mesh laminate of the present invention.

Therefore, for the manufacture of the base layer, use is made of previously plasticized PVC, in the form of granules, extruded or calendered sheets or in the form of a viscous mass hot-extruded directly onto the mat/laminate complex.

A manufacturing method using extruded PVC sheets is described for example in international application WO2020/152408.

When plasticized PVC sheets are used, the sheets are preferably attached to the reinforcement by thermolamination.

The upper face of the base layer is then printed with a decoration, referred to as decorative layer, which will be visible through the transparent or translucent wear layer covering the decorative layer. The decorative layer can in principle be applied by any known printing method and mention will be made here, by way of examples, of screen printing, photogravure printing, off-set printing and inkjet printing.

According to the invention, the upper wear layer is transparent or translucent to visible light, so that the decorative layer printed on the upper face of the base layer can be visible through the wear layer. The wear layer is generally produced from a thermoplastic polymer, for example from poly(vinyl chloride). This layer preferably has a thickness of between 0.10 and 1.0 mm. The wear layer can be obtained by extrusion, by calendering, by pressing, or by coating/gelling a plastisol. Preferably, the wear layer is a gelled PVC plastisol layer, advantageously comprising from 20 to 70 parts of plasticizer per 100 parts of PVC resin. The plasticizers can be selected for example from those listed above in relation to the PVC of the base layer.

The flexible slab for floor coverings of the present invention may further comprise a support layer which is in contact with the lower face of the base layer. The support layer is preferably produced from expanded or non-expanded poly(vinyl chloride) (PVC), and advantageously has a thickness of between 0.4 and 5 mm, preferably between 0.4 and 3 mm.

The support layer may be compact (dense) or foamed (expanded) and may comprise one or more sub-layers. It can be obtained by any process that is well known to the person skilled in the art, in particular by calendering, pressing, extrusion or coating/gelling.

When it is a foam-type layer, the density can be between 0.2 and 0.5 g/cm³, preferably between 0.30 and 0.40 g/cm³.

### EXAMPLES

A slab A according to the invention and a comparative slab B were prepared, having the following technical characteristics:

### Slab A:

PVC base layer reinforced by a mat/mesh laminate with a nonwoven mat of glass fibers E having a length of 18 mm and a diameter of 13 μm, bonded by a urea/formaldehyde binder, mass per unit area of 35 g/m², LOI 20%, air permeability 9200 l/m²·s at 200 Pa, and a knitted mesh (density 3.5 yarns/cm; 34 tex (warp); 68 tex (weft); acrylic binder). The total thickness of the slab (including wear layer, base layer and support layer) is 4 mm.

### Slab B:

PVC base layer reinforced by a nonwoven mat of glass fibers E having a length of 18 mm and a diameter of 13 μm, bonded by a urea/formaldehyde binder, mass per unit area of 35 g/m², LOI 20%, air permeability 9200 l/m²·s at 200 Pa. The thickness of the slab (including wear layer, base layer and support layer) is 4 mm.

The thermal expansion of these two slabs is measured as follows by dynamic mechanical thermal analysis (DMTA) using a DMTA apparatus, model Q800 from TA Instruments:

The PVC slab is cut into samples of 25 mm×6 mm (in the longitudinal (warp) and transverse (weft) direction). The sample is attached between two jaws of the DMTA apparatus that place the sample under tensile stress, then an oven is closed around the sample. The sample is then subjected to a periodic mechanical tensile stress: deformation of 0.001%, frequency 1 Hz.

The sample is first cooled at a rate of 2° C./min from room temperature to 5° C., then heated at a rate of 1° C./min to 50° C., and cooled again to the temperature of 5° C. at a rate of 2° C./min. The heating/cooling cycle is carried out 3 times in total for each sample.

During the second and third cycle, the increase in the length of the sample is recorded between 12° C. (L12) and 38° C. (L38), and the expansion is calculated over this temperature range according to the following formula:

$$Expansion ( \% ) \text{:} 100 ⨯ ( {L}_{38} - {L}_{12} ) / {L}_{12}$$

The results correspond to the mean calculated over the two heating/cooling cycles.

For the slab A according to the invention, the thermal expansion is 0.13% in the direction of the 34 tex warp yarns (machine direction) and between 0.11 and 0.14% in the direction of the 68 tex weft yarns (cross-machine direction).

For comparative slab B, thermal expansion is 0.19% in the “warp” direction (machine direction) and 0.22% in the “weft” direction (cross-machine direction).

These results show that the use of glass fiber mat/glass yarn mesh laminate according to the invention makes it possible to effectively limit the thermal expansion of the flexible slabs compared to identical slabs reinforced by a simple nonwoven glass fiber mat.

The slabs do not exhibit any problems of delamination.

1. A mat/mesh laminate, formed
by a glass fiber mat, bonded by a first organic polymer, having an air permeability, measured in accordance with standard NF EN ISO 9237 at a pressure of 200 Pa, of between 6000 and 12,000 l/m²·s,
and by a glass yarn mesh having a titer of between 30 and 150 tex that is coated with a second organic polymer.

2. The mat/mesh laminate according to claim 1, wherein the glass yarn mesh is adhesively bonded to the glass fiber mat by means of the second organic polymer.

3. The mat/mesh laminate according to claim 1, wherein the glass fibers forming the glass fiber mat have a diameter of between 12 and 17 μm, and a length of between 12 and 25 mm.

4. The mat/mesh laminate according to claim 1, wherein the glass fiber mat has a mass per unit area of between 25 and 50 g/m².

5. The mat/mesh laminate according to claim 1, wherein the glass fiber mat has a thickness of between 250 μm and 500 μm.

6. The mat/mesh laminate according to claim 1, wherein the glass yarn mesh consists of weft yarns and warp yarns all having the same titer.

7. The mat/mesh laminate according to claim 1, wherein a density of the weft yarns and warp yarns is between 3 and 4 yarns/cm.

8. The mat/mesh laminate according to claim 1, wherein the glass yarns have between 10 and 30 twists/m.

9. The mat/mesh laminate according to claim 1, wherein the laminate has a mass per unit area of between 70 and 150 g/m², and a thickness of between 0.45 and 0.80 mm.

10. The mat/mesh laminate according to claim 1, wherein the mesh is a knitted mesh, a woven mesh or a spun mesh.

11. A flexible floor covering slab based on poly(vinyl chloride) (PVC) comprising, as single reinforcement, a mat/mesh laminate according to claim 1.

12. The flexible floor covering slab according to claim 11, comprising:
a base layer including an upper face and a lower face, said base layer consisting of a mat/mesh laminate according to claim 1 and of two layers made of plasticized PVC in contact respectively with the two faces of the mat/mesh laminate,
a decorative layer printed on the upper face of the base layer,
a transparent wear layer, covering the decorative layer printed on the upper layer of the base layer.

13. The flexible floor covering slab according to claim 11, further comprising a support layer, in contact with the lower face of the base layer.

14. The flexible floor covering slab according to claim 11, wherein the base layer has a total thickness of between 0.8 and 2.8 mm and wherein the transparent wear layer has a thickness of between 0.1 mm and 1.0 mm.

15. The mat/mesh laminate according to claim 4, wherein the glass fiber mat has a mass per unit area of between 30 and 45 g/m².

16. The mat/mesh laminate according to claim 15, wherein the glass fiber mat has a mass per unit area of between 32 and 39 g/m².

17. The mat/mesh laminate according to claim 5, wherein the glass fiber mat has a thickness of between 270 μm and 400 μm.

18. The mat/mesh laminate according to claim 8, wherein the glass yarns have from 15 to 28 twists/m.

19. The mat/mesh laminate according to claim 9, wherein the laminate has a mass per unit area of between 75 and 120 g/m² and a thickness of between 0.50 and 0.75 mm.

20. The mat/mesh laminate according to claim 10, wherein the mesh is a knitted mesh.
